(19) United States
(12) Patent Application Publication
(10) Pub. No.: US 2014/0244095 A1
(43) Pub. Date: Aug. 28, 2014

(54) APPARATUS AND METHOD FOR GUIDING PARKING

(71) Applicant: Hyundai Motor Company, Seoul (KR)

(72) Inventors: Jae Seob Choi, Hwaseong (KR); Dae Joong Yoon, Hwaseong (KR); Eu Gene Chang, Gunpo (KR)

(21) Appl. No.: 13/908,214

(22) Filed: Jun. 3, 2013

(30) Foreign Application Priority Data
Feb. 28, 2013 (KR) 10-2013-0022156

(51) Int. Cl. B62D 15/02

(52) U.S. Cl. CPC B62D 15/0285
USPC 701/25

(57) ABSTRACT

A parking guidance method and apparatus that includes a controller that is configured to recognize and determine a user selected area as a target parking area when a vehicle parking mode is operated. In addition, the controller is configured to calculate a parking starting point based on the determined target parking area and calculate a parking trajectory from the parking starting point. The controller is configured to generate operation guidance information that induces the vehicle to the parking starting point based on the selected parking starting point and a location of the vehicle and for guiding parking from the parking starting point to the target parking area. Further, the controller is configured to set up a guidance screen that includes generated information when the vehicle is operated in the parking mode.

### CROSS-REFERENCE TO RELATED APPLICATION

This application is based on and claims priority from Korean Patent Application No. 10-2013-0022156, filed on Feb. 28, 2013 in the Korean Intellectual Property Office, the disclosure of which is incorporated herein in its entirety by reference.

### BACKGROUND

1. Field of the Invention

The present invention relates generally to an apparatus and a method for guiding parking, and more particularly, to a technology of guiding a vehicle location and an operation method of the parking guidance apparatus for a driver to park more easily.

2. Description of the Related Art

Generally, a parking guidance system recognizes a parking space in the vicinity of a vehicle using an ultrasonic sensor to guide parking and, for manual parking, the parking guidance system recognizes a parked vehicle or an obstacle to guide the vehicle and decrease a risk of collision with a corresponding vehicle in advance.

In a vehicle which supports an around view monitor (AVM) system, parking of the vehicle may be guided using a top view image from a side, a rear, or in every direction. In this case, a user may avoid the collision with a nearby vehicle or obstacle while parking, however, the user may feel pressure when parking because the user needs to view the AVM image and, at the same time, determines a direction of the vehicle, a stopping time point, and a direction and an angle of a steering wheel until the vehicle is parked at a target parking position.

### SUMMARY

The present invention provides an apparatus and a method for parking guidance which provides guidance to a vehicle location and an operation method of the parking guidance apparatus for a driver to park more easily in a vehicle parking mode.

In addition, the present invention provides an apparatus and a method for parking guidance which reduces difficulty in performing parking by providing a guidance message in real time that induces a location change of a vehicle while parking, a moving time point, a stopping time point, a heading direction, a speed, a travel distance, an operation direction and an angle of a steering wheel of the vehicle, etc., based on a location change and an operation status of the vehicle.

Further, the present invention provides an apparatus and a method for parking guidance which enables a user to recognize parking guidance information more easily by configuring a guidance screen that includes guidance information for parking support and displaying the guidance screen in real time.

According to an aspect of the present invention, a parking guidance apparatus may include: a target parking area recognition unit that recognizes and determines an area selected by a user as a target parking area when a vehicle parking mode is operated; a calculation unit that calculates a parking starting point based on the determined target parking area and calculates a parking trajectory from the parking starting point; a vehicle operation information generation unit that generates operation guidance information for inducing the vehicle to the parking starting point based on the parking starting point selected by the user and a location of the vehicle and for supporting parking from the parking starting point to the target parking area; and a screen configuration unit that configures a guidance screen that includes information generated from the calculation unit or the vehicle operation information generation unit when the vehicle is operated in the parking mode. The target parking area recognition unit may be configured to determine a parking lot selected by the user or an empty area which does not have a parking lot line and is designated by the user as the target parking area.

According to another aspect of the present invention, a parking guidance apparatus may further include a vehicle information collection unit that collects location information of the vehicle and operation status information of the vehicle when the vehicle is operated in the parking mode. The vehicle operation information generation ay be configured to generate the operation guidance information of the vehicle in real time, based on a change in the location information of the vehicle and the operation status of the vehicle, based on the target parking area. The screen configuration unit may be configured to set up (e.g., configure) a selection screen that guides the parking starting point and the parking trajectory calculated by the calculation unit and receive lection of the parking starting point and set up a parking induction screen that includes the operation guidance information generated in real time by the vehicle operation information generation unit. The vehicle guidance information may include at least one of a group consisting of: a guidance message that induces a location change to the parking starting point or the target parking area for the vehicle, a moving time point, a stopping time point, a heading direction, a speed, a travel distance, an operation direction and an angle of a steering wheel of the vehicle.

According to an aspect of the present invention, a parking guidance apparatus may further include a display that displays the guidance screen configured by the screen configuration unit.

According to yet another aspect of the present invention, a parking guidance method may include: recognizing and determining, by a controller, an area selected by a user as a target parking area when a vehicle parking mode is operated; calculating, by the controller, a parking starting point based on the determined target parking area and calculating a parking trajectory from the parking starting point; generating, by the controller, operation guidance information that induces the vehicle to the parking starting point based on the parking starting point selected by the user and a location of the vehicle and that guides parking from the parking starting point to the target parking area; and configuring, by a controller, a guidance screen that includes information generated when the vehicle is operated in the parking mode.

The determining of the target parking area may include determining, by the controller, a parking lot selected by the user or an empty area which does not have a parking lot line and designated by the user as the target parking area.

According to another aspect of the present invention, a parking guidance method may further include collecting, by the controller, location information of the vehicle and operation status information of the vehicle when the vehicle is operated in the parking mode. The generating the vehicle operation information may include generating, by the controller, the operation guidance information of the vehicle in real time, based on a change in the location information of the vehicle and the operation status of the vehicle, based on the target parking area. The configuring the guidance screen may include: configuring, by the controller, a selection screen that guides the calculated parking starting point and parking trajectory and receives selection of the parking starting point; and configuring a parking induction screen that includes the operation guidance information generated in real time.

According to another aspect of the present invention, a parking guidance method further may further include displaying, by the controller, the guidance screen configured by the screen configuration unit.

### BRIEF DESCRIPTION OF THE DRAWINGS

The objects, features and advantages of the present invention will be more apparent from the following detailed description in conjunction with the accompanying drawings, in which:

FIG. 1 is an exemplary block diagram illustrating a configuration of a parking guidance apparatus according to an exemplary embodiment of the present invention;

FIGS. 2A-2E are exemplary views for explaining a parking guidance operation of the parking guidance apparatus according to an exemplary embodiment of the present invention;

FIGS. 3A-3B and 4A-4B are exemplary views illustrating a selection screen configured by a parking guidance apparatus according to an exemplary embodiment of the present invention;

FIG. 5 is an exemplary view illustrating a parking trajectory guidance screen calculated by a parking guidance apparatus according to an exemplary embodiment of the present invention;

FIGS. 6A-6C, 7A-7C and 8A-8C are exemplary views illustrating an operation guidance screen configured by the parking guidance apparatus according to an exemplary embodiment of the present invention; and

FIG. 9 is an exemplary flowchart illustrating an operation flow of a parking guidance method according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, fuel cell vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic, of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

Hereinafter, various embodiments of the present invention will be described with reference to the accompanying drawings.

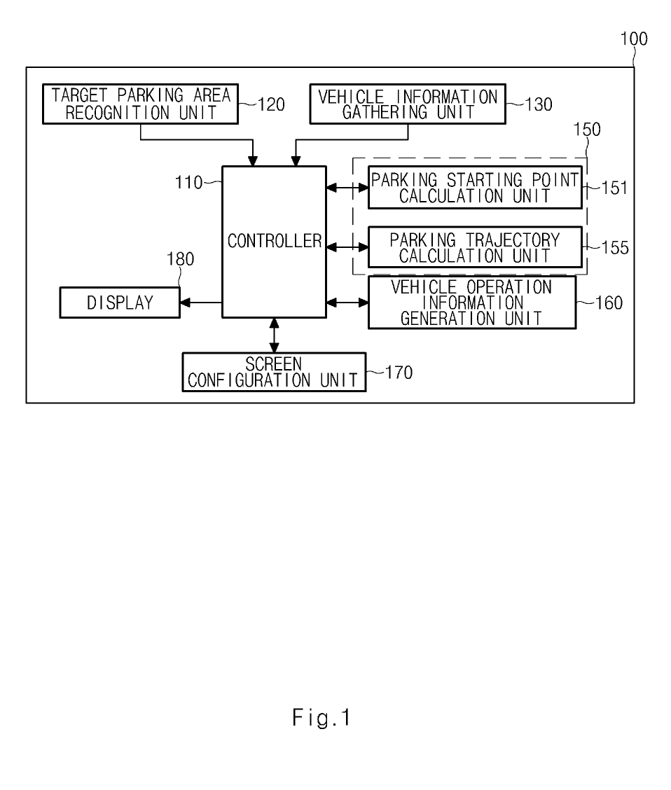

FIG. 1 is an exemplary block diagram illustrating a configuration of a parking guidance apparatus according to the present invention. Referring to FIG. 1, the parking guidance apparatus according to the present invention (hereinafter, “parking guidance apparatus”) 100 may include a controller 110 and a plurality of units executed by the controller 110. The plurality of units may include: a target parking area recognition unit 120, a vehicle information gathering unit 130, a calculation unit 150, a vehicle operation information generation unit 160, a screen configuration unit 170, and a display 180. Specifically, the controller 110 may be configured to execute an operation of each unit of the parking guidance apparatus 100 according to the present invention.

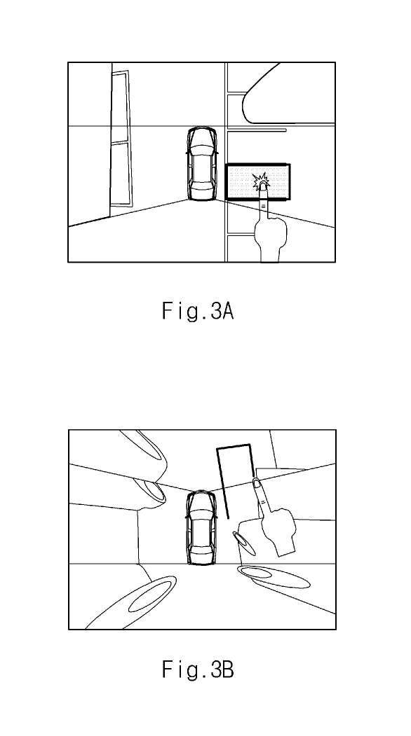

The target parking area recognition unit 120 may be configured to determine a target parking area by recognizing an area selected by a user when a vehicle parking mode is operated. In particular, the display 180 may be a touch screen type, and the user may select a desired parking area within an AVM image displayed on the display 180. In addition, the area selected by the user may be an empty parking lot or an area designated by the user in an empty area where a parking lot line does not exist. An operation of receiving selection by the user of the parking area will be described in more detail with reference to FIG. 3.

The vehicle information gathering unit 130 may be configured to gather location information of the vehicle and operation status information of the vehicle while the vehicle is operated as parking mode. For example, the vehicle information gathering unit 130 may be configured to gather the location information of the vehicle via a distance measuring sensor such as global positioning system (GPS) module or an ultrasonic sensor. In addition, the vehicle inform gathering unit 130 may be configured to collect the operation status information of the vehicle via a controller that executes an operation of an accelerator, a brake, a gear, and a steering wheel of the vehicle or a sensor equipped in each unit. Further, the vehicle information gathering unit 130 may additionally be configured to gather the vehicle information such as a length, a width, and a maximum rotation angle of the vehicle.

The calculation unit 150 may include a parking starting point calculation unit 151 and a parking trajectory calculation unit 155. In particular, the parking starting point calculation unit 151 may be configured to calculate a parking starting point at which the vehicle may be easily parked based on the target parking area determined by the target parking area recognition unit 120. In addition, the parking starting point calculation unit 151 may be configured to calculate a plurality of parking starting points of parking patterns supported with respect to the target parking area.

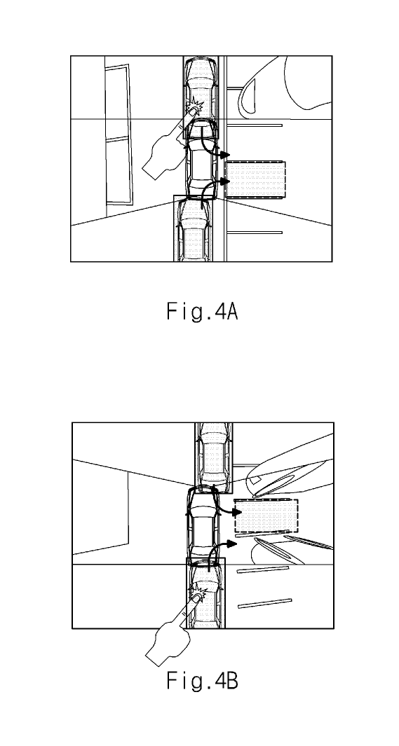

For example, the parking starting point calculation unit 151 may be configured to calculate a parking starting point for a forward parking and a parking starting point for a reverse parking based on the target parking area. In particular, information about the parking starting point calculated by the parking starting point calculation unit 151 may be displayed on the display 180 through a guidance screen configured by the screen configuration unit 170. Therefore, the user may select the parking starting point displayed on the display 180. An operation of receiving the parking starting point from the user will be described in more detail with reference to FIG. 4.

The parking trajectory calculation unit 155 may be configured to calculate a parking trajectory from at least one parking starting point calculated by the parking starting point calculation unit 151 to the target parking area. In particular, the parking trajectory calculation unit 155 may be configured to calculate a full-turn based parking trajectory based on the vehicle information such as the length, the width, and the maximum rotation angle of the vehicle. In addition, the parking trajectory calculated by the parking trajectory calculation unit 155 may be displayed on the display 180 through the guidance screen configured by the screen configuration unit 170 and may be displayed with the guidance screen of the parking starting point upon display of the guidance screen of the parking starting point.

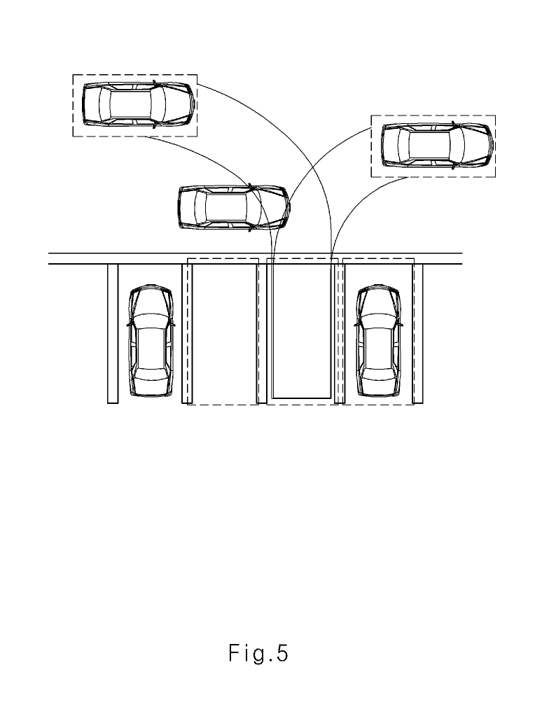

Specifically, the screen configuration unit 170 may be configured to guide the parking starting point and the parking trajectory, and simultaneously, set up a selection screen that receives a selection of the parking starting point from the user, and display the selection screen through the display 180. An exemplary embodiment for displaying the guidance screen including the full-turn based parking trajectory will be described with reference to FIG. 5.

When one of at least one parking starting point calculated by the parking starting point calculation unit 151 is selected by the user, the vehicle operation information generation unit 160 may be configured to generate operation guidance information that induces the vehicle to the parking starting point based on the selected parking starting point and a current location of the vehicle. In addition, when the vehicle moves to the parking starting point based on the generated operation guidance information, the vehicle operation information generation unit 160 may be configured to generate operation guidance information that guides parking from the parking starting point to the target parking area. In particular, the operation guidance information may include at least one of a guidance message that induces a location change to the parking starting point or the target parking area for the vehicle, a moving time point, a stopping time point, a heading direction, a speed, a travel distance, and an operation direction and an angle of a steering wheel of the vehicle.

Furthermore, the vehicle operation information generation unit 160 may be configured to generate the operation guidance information of the vehicle in real time based on a change in the location information of the vehicle and the operation status of the vehicle, based on the parking starting point or the target parking area. The operation guidance information generated by the vehicle operation information generation unit 160 may be displayed on the display 180 through the guidance screen configured by the screen configuration unit 170.

Although not shown in FIG. 1, the operation guidance information generated by the vehicle operation information generation unit 160 may be output in a form of a voice through a speaker.

The screen configuration unit 170 may be configured to set up (e.g., configure) the guidance screen that includes information generated by the calculation unit 150 and the vehicle operation information generation unit 160 while the vehicle is operated under the parking mode. For example, the screen configuration unit 170 may be configured to guide the parking starting point and parking trajectory calculated by the calculation unit 150 and set up the selection screen to receive selection of the parking starting point. In addition, the screen configuration unit 170 may be configured to set up a parking inducement screen that includes the operation guidance information generated in real time by the vehicle operation information generation unit 160.

Additionally, the display 180 may be configured to display the guidance screen set up by the screen configuration unit 170 and provide location change inducement information and the operation guidance information to the user in real time. Therefore, the user may verify the guidance information provided through the guidance screen displayed on the display 180 whenever a location of the vehicle changes and, in this manner, the user may perform parking of the vehicle in an easier and simpler way.

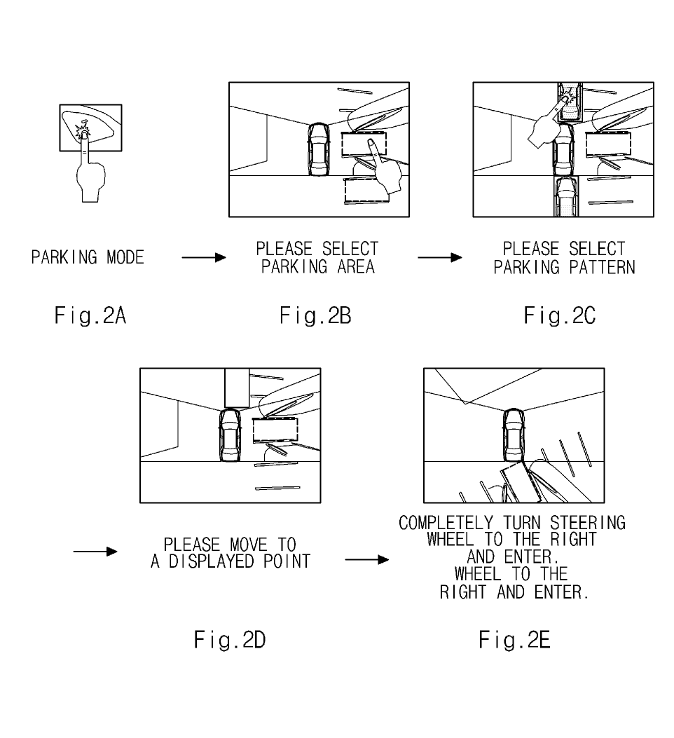

FIG. 2 is an exemplary view for explaining a parking guidance operation of the parking guidance apparatus according to the present invention. Referring to FIG. 2, when the vehicle is switched to the parking mode by operating a parking mode button shown in (a), the parking guidance apparatus according to the present invention may be configured to set up a screen that receives selection of a parking location from the user and display the screen through the display, as shown in (b). In particular, the user may select an empty parking lot or place a square box or draw the square box directly on an empty area which does not have a parking lot line.

When the parking area is selected through the screen of (b), the parking guidance apparatus may be configured to determine the parking area selected from (b) as the target parking area and receive a parking pattern from the user by calculating the parking starting point and the parking trajectory for each possible parking pattern based on the target parking area and display the parking starting point and the parking trajectory through the display, as shown in (c).

In particular, when the parking pattern is determined according to the user's selection of one of the parking starting point, the parking guidance apparatus may be configured to set up and display a screen that induces the vehicle to move to the parking starting point through the display, as shown in (d). In addition, when the vehicle moves to the parking starting point, the parking guidance apparatus may be configured to provide, in real time, the operation guidance information that guides parking from the parking starting point to the target parking area, as shown (e).

FIGS. 3 and 4 are exemplary views illustrating a selection screen configured by a parking guidance apparatus according to the present invention.

First, FIG. 3 shows a detailed operation of FIG. 2(b) and shows an operation of receiving the parking area from the user. In particular, the user may select the parking area by selecting any one of an empty parking lot displayed on a screen, as in FIG. 3(a). In addition, the user may select the parking area by placing the square box or drawing the square box directly in an empty area which does not have the parking lot line, as shown in FIG. 3(b).

FIG. 4 shows an exemplary detailed operation of FIG. 2(c) and shows an operation of receiving the parking starting point from the user. The parking guidance apparatus may be configured to calculate and display, through the display, the parking starting point for each parking pattern. In particular, the user may select the parking starting point based on a reverse parking pattern as in FIG. 4 (a) and may select the parking starting point based on a forward parking pattern as in FIG. 4 (b). Although FIG. 4 only shows the forward parking and the reverse parking, it should be noted that the parking starting point may be calculated and provided for various parking patterns.

FIG. 5 is an exemplary view illustrating a parking trajectory guidance screen calculated by a parking guidance apparatus according to the present invention. As shown in FIG. 5, the parking guidance apparatus may be configured to calculate and display, through the display, the full-turn pattern of the parking trajectory based on the length, the width, and the maximum rotation angle of the vehicle. The full-turn pattern of the parking trajectory may enable a detailed operation of the vehicle compared to a line segment pattern of the parking trajectory and enable the user to recognize whether the user deviates from the parking trajectory more easily.

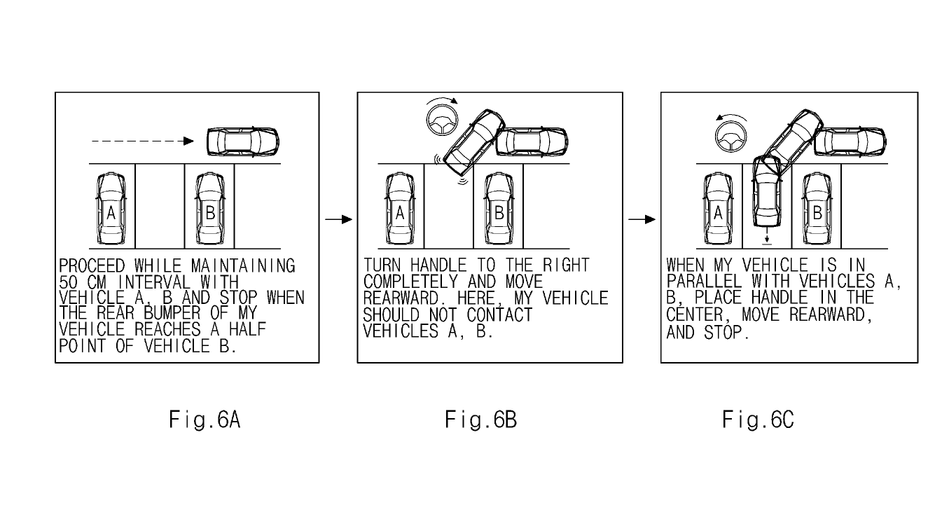

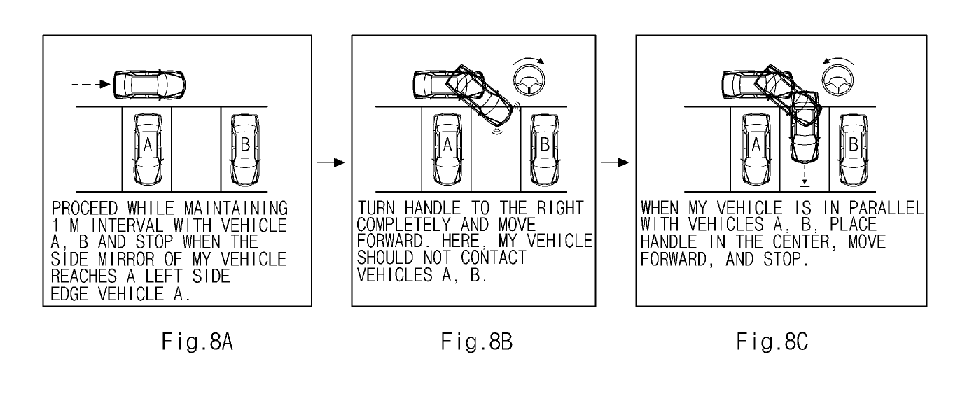

FIGS. 6 and 8 are exemplary views illustrating an operation guidance screen configured by the parking guidance apparatus according to the present invention.

First, FIG. 6 shows an exemplary pattern of reverse parking at a right angle. Referring to FIG. 6, the parking guidance apparatus may be configured to display, on the display, a guidance screen that induces the vehicle to move to the determined parking starting point by driving forward while maintaining an interval of about 50 cm from parked vehicles in a lateral direction, as in (a). In particular, the stopping point may be guided together. Next, when the vehicle arrives at the parking starting point, the parking guidance apparatus may be configured to guide an operation direction and an angle of the steering wheel, a driving direction (reverse direction), and the stopping point, as in (b) and (c) to allow the vehicle to be reverse parked at a right angle in an easy and convenient manner.

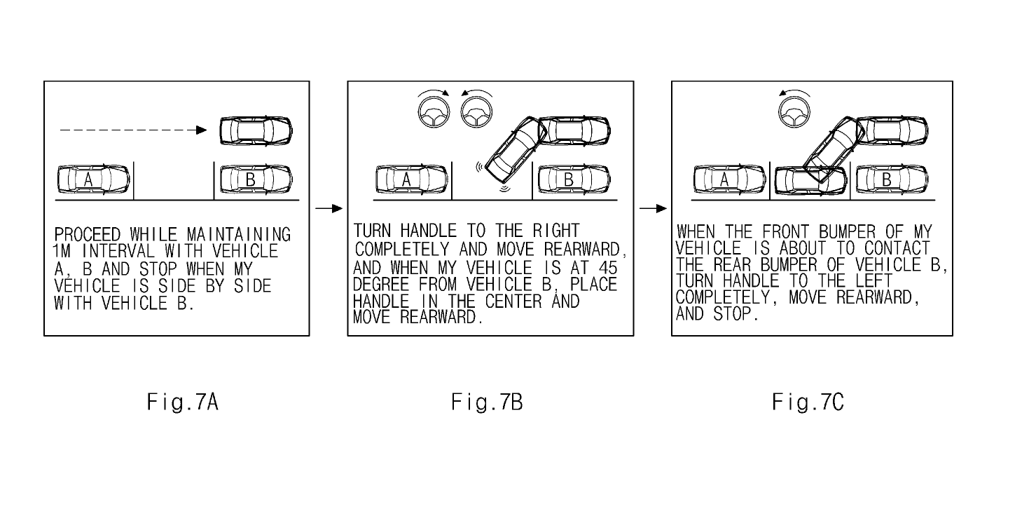

Meanwhile, FIG. 7 shows an exemplary pattern of a parallel reverse parking. Referring to FIG. 7, the parking guidance apparatus may be configured to display, on the display, the guidance screen that induces the vehicle to move to the determined parking starting point by driving forward while maintaining an interval of about 1 m in the lateral direction from other parked vehicles, as (a). In the same manner, the stopping pint may be guided together.

Further, when the vehicle arrives at the parting starting point, the parking guidance apparatus may be configured to guide the operation direction and the angle of the steering wheel, the driving direction (reverse direction), and the stopping point, as in (b) and (c) to allow the vehicle to be parallel reverse parked in an easy and convenient manner.

Meanwhile, FIG. 8 shows an exemplary pattern of forwarding parking at a right angle. Referring to FIG. 8, the parking guidance apparatus may be configured to display the guidance screen that induces the vehicle to move to the determined parking starting point by forward driving while maintaining an interval of about 1 m from parked vehicles in the lateral direction, as shown in (a). Additionally, the stopping point may be guided together. Furthermore, when the vehicle arrives at the parking starting point, the parking guidance apparatus may be configured to guide the operation direction and the angle of the steering wheel, the driving direction (reverse direction), and the stopping point, as shown in (b) and (c) so that the vehicle may be forward parked at a right angle in an easy and convenient manner.

An operation flow of the parking guidance apparatus according to the present invention configured as above is described in detail below.

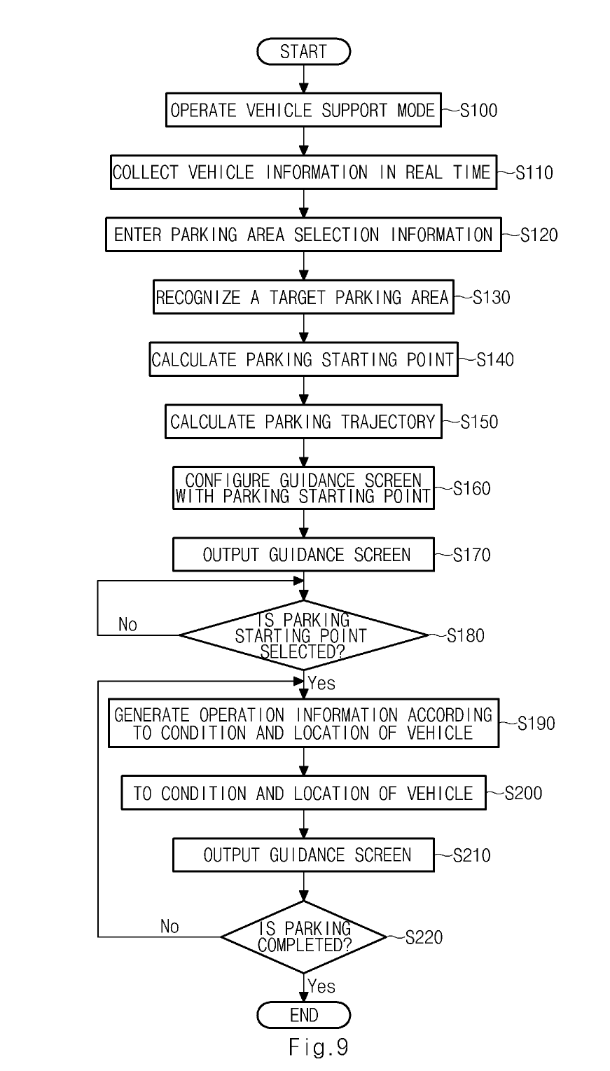

FIG. 9 is an exemplary flowchart illustrating an operation flow of a parking guidance method according to the present invention. As shown in FIG. 9, when operated in the parking supporting mode (S100), the parking guidance apparatus may be configured to gather the vehicle information in real time (S110). In particular, the information gathered at step S110 may be displayed on the display in a form of the AVM image. When the user enters parking location selection information (S120), the target parking area may be recognized, by the controller, based on the parking location selected in step S120 (S130). Specifically, the parking guidance apparatus may be configured to calculate the parking starting point based on the target parking area recognized in step S130 (S140) and calculate the parking trajectory from the parking starting point to the target parking area (S150). In addition, the parking guidance apparatus may be configured to set up a parking starting point guidance screen based on the parking starting point and the parking trajectory information calculated in steps S140 and S150 (S160) and display the guidance screen through the display (S170).

Furthermore, when any one of the parking starting point is selected by the user (S180), the operation guidance information may be generated, by the controller, based on a condition and the location of the vehicle (S190), the vehicle operation guidance screen may be configured (S200), by the controller, and the configured guidance screen may be output, by the controller, through the display (S210). Steps S190 to S210 may be repeatedly performed until the parking is completed, and when the parking is completed (S220), the parking guidance may be terminated.

According to the present invention, in a vehicle parking mode, a guidance message that induces a location change of a vehicle while parking a vehicle, a moving time point, a stopping time point, a heading direction, a speed, a travel distance, an operation direction and an angle of a steering wheel of the vehicle, etc., may be provided in real time based on a location change and an operation status of the vehicle, and thus, the present invention is advantageous in that difficulty in performing parking may be reduced.

Further, the present invention may configure a guidance screen that includes guidance information for parking support and display the guidance screen in real time, and thus, the present invention is advantageous in that a user may recognize parking guidance information more easily.

While the present invention has been shown and described with reference to exemplary embodiments thereof, it will be understood by those skilled in the art that various changes in form and details may be made therein without departing from the spirit and scope of the present invention as defined by the accompanying claims.

What is claimed is:

1. A parking guidance apparatus comprising:
a controller configured to:
recognize and determine a user selected area as a target parking area when a vehicle parking mode is operated;
calculate a parking starting point based on the determined target parking area;
calculate a parking trajectory from the parking starting point;
generate operation guidance information that induces the vehicle to the parking starting point based on the user selected parking starting point and a location of the vehicle and guides parking from the parking starting point to the target parking area; and
set up a guidance screen that includes generated information when the vehicle is operated in the parking mode.

2. The parking guidance apparatus of claim 1, wherein the controller is further configured to:
determine a selected parking lot or an empty area which does not have a parking lot line and designated as the target parking area.

3. The parking guidance apparatus of claim 1, wherein the controller is further configured to:
collect location information of the vehicle and operation status information of the vehicle when the vehicle is operated in the parking mode.

4. The parking guidance apparatus of claim 3, wherein the controller is further configured to:
generate the operation guidance information of the vehicle in real time, based on a change in the location information of the vehicle and the operation status of the vehicle, based on the target parking area.

5. The parking guidance apparatus of claim 1, wherein the controller is configured to:
set up a selection screen that guides the parking starting point and the calculated parking trajectory;
receive a selection of the parking starting point; and
set up a parking induction screen that includes the operation guidance information generated in real time.

6. The parking guidance apparatus of claim 1, wherein the vehicle guidance information is selected from at least one of a group consisting of: a guidance message that induces a location change to the parking starting point or the target parking area for the vehicle, a moving time point, a stopping time point, a heading direction, a speed, a travel distance, an operation direction, and an angle of a steering wheel of the vehicle.

7. The parking guidance apparatus of claim 1, wherein the controller is further configured to:
display the guidance screen via a display.

8. A parking guidance method comprising:
recognizing and determining, by a controller, a user selected area as a target parking area when a vehicle parking mode is operated;
calculating, by the controller, a parking starting point based on the determined target parking area;
calculating, by the controller, a parking trajectory from the parking starting point;
generating, by the controller, operation guidance information that induces the vehicle to the parking starting point based on the selected parking starting point and a location of the vehicle and for guiding parking from the parking starting point to the target parking area; and
configuring, by the controller, a guidance screen that includes information generated when the vehicle is operated in the parking mode.

9. The parking guidance method of claim 8, wherein the determining the target parking area includes:
determining, by the controller, a selected parking lot or an empty area which does not have a parking lot line and designated as the target parking area.

10. The parking guidance method of claim 8, further comprising:
collecting, by the controller, location information of the vehicle and operation status information of the vehicle when the vehicle is operated in the parking mode.

11. The parking guidance method of claim 10, wherein the generating the vehicle operation information includes:
generating, by the controller, the operation guidance information of the vehicle in real time, based on a change in the location information of the vehicle and the operation status of the vehicle, based on the target parking area.

12. The parking guidance method of claim 8, wherein the configuring the guidance screen includes:
configuring, by the controller, a selection screen for guiding the calculated parking starting point and parking trajectory and receiving selection of the parking starting point; and
configuring, by the controller, a parking induction screen that includes the operation guidance information generated in real time.

13. The parking guidance method of claim 8, further comprising:
displaying, by the controller, the configured guidance screen.

14. A non-transitory comp readable medium containing program instructions executed by a processor or controller, the computer readable medium comprising:
program instructions that recognize and determine a user selected area as a target parking area when a vehicle parking mode is operated;
program instructions that calculate a parking starting point based on the determined target parking area;
program instructions that calculate a parking trajectory from the parking starting point;
program instructions that generate operation guidance information that induces the vehicle to the parking starting point based on the selected parking starting point and a location of the vehicle and for guiding parking from the parking starting point to the target parking area; and
program instructions that configure a guidance screen that includes information generated when the vehicle is operated in the parking mode.

15. The non-transitory computer readable medium of claim 14, further comprising:
program instructions that determine a selected parking lot or an empty area which does not have a parking lot line and designated as the target parking area.

16. The non-transitory computer readable medium of claim 14, further comprising:
program instructions that collect location information of the vehicle and operation status information of the vehicle when the vehicle is operated in the parking mode.

17. The non-transitory computer readable medium of claim 16, further comprising:
program instructions that generate the operation guidance information of the vehicle in real time, based on a change in the location information of the vehicle and the operation status of the vehicle, based on the target parking area.

18. The non-transitory computer readable medium of claim 14, further comprising:
program instructions that configure a selection screen for guiding the calculated parking starting point and parking trajectory and receiving selection of the parking starting point; and
program instructions that configure a parking induction screen that includes the operation guidance information generated in real time.

19. The non-transitory computer readable medium of claim 14, further comprising:
program instructions that display the configured guidance screen.
